(19) United States
(12) Patent Application Publication
(10) Pub. No.: US 2026/0338407 A1
(43) Pub. Date: Oct. 29, 2026

(54) SLEEVE FOR RECEIVING A BALL JOINT ACCOMMODATING A ROTATION SHAFT OF A BLADED MEMBER OF A VENTILATION DEVICE

(71) Applicant: VALEO SYSTEMES THERMIQUES, Le Mesnil-Saint-Denis (FR)

(72) Inventors: Jerome Blanchard, Le Mesnil-Saint-Denis (FR); Patrick Boisselle, Le Mesnil-Saint-Denis (FR); Samuel Bry, Le Mesnil-Saint-Denis (FR); Philippe Lemercier, Le Mesnil-Saint-Denis (FR); Véronique Monnet, Le Mesnil Saint Denis (FR)

(73) Assignee: VALEO SYSTEMES THERMIQUES, Le Mesnil-Saint-Denis (FR)

(21) Appl. No.: 19/109,946

(22) PCT Filed: Aug. 23, 2023
(86) PCT No.: PCT/EP2023/073092

§ 371 Date: Mar. 7, 2025

(30) Foreign Application Priority Data
Sep. 8, 2022 (FR) FR2208996

(51) Int. Cl. F24F 13/08; F24F 7/00

(52) U.S. Cl. CPC F24F 13/08; F24F 7/00

(57) ABSTRACT

A ventilation device which extends in an axial direction and which includes a bladed member and an electric motor. The bladed member includes a protection casing for the blades. The electric motor includes a rotor which rotates the bladed member via a first shaft having an axis which extends from a first end of the bladed member. The bladed member includes a second shaft having the axis which extends from a second end of the bladed member, and which is mounted in an assembly including a sleeve for receiving a ball joint which receives a rotation shaft of a bladed member of the ventilation device. A method for assembling the ventilation device and a cooling module for a motor vehicle including the ventilation device are also disclosed herein.

### TECHNICAL FIELD OF THE INVENTION

The invention relates to a sleeve for receiving a ball joint which receives a rotation shaft of a bladed member of a ventilation device.

The invention further relates to the assembly which is constituted by the sleeve and the ball joint.

It then relates to the ventilation device itself.

The invention also relates to a method for mounting the ventilation device.

And, finally, the invention relates to a cooling module for a motor vehicle, comprising such a ventilation device.

### TECHNICAL BACKGROUND

A cooling module (or heat exchange module) of a motor vehicle conventionally comprises at least one heat exchanger and a ventilation device which is designed to generate an air flow in contact with the heat exchanger, when the vehicle is stopped or traveling slowly.

In motor vehicles with a conventional combustion engine, the heat exchanger is positioned facing at least two cooling openings formed in the front end of the body of the motor vehicle. A first cooling opening is located above the bumper while a second opening is located below the bumper. Such a configuration is preferred since the combustion engine must also be supplied with air, the air intake of the engine conventionally being located in the passage of the stream of air passing through the upper cooling opening.

However, electric vehicles are preferably provided with a single cooling opening which is located under the bumper.

This is because the electric motor does not need to be supplied with air. The reduction in the number of cooling openings also makes it possible to improve the aerodynamic characteristics of the electric vehicle. This also results in better range and a higher top speed of the motor vehicle.

In order to adapt to a smaller number of cooling openings, it is particularly advantageous to use a member with tangential blades in order to generate an air path toward the heat exchanger.

This member with tangential blades is rotated by the electric motor.

The bladed member is mounted in a casing in terms of rotation. A first shaft extends from a first lateral end of the bladed member and is connected to the rotor of the motor. A second shaft extends from a second lateral end of the bladed member.

The two shafts are positioned in the casing in a precise manner relative to each other, along the same axis, which corresponds to the rotation axis of the bladed member and the rotor.

The first shaft is mounted in a roller bearing which is arranged in a cylindrical bearing surface which is provided for this purpose in the casing of the bladed member. The roller bearing is mounted in a clamped state in the bearing surface so as to guide the shaft correctly.

The second shaft is mounted in a clamped state in a ball joint which is movable in terms of rotation in an elastomer sleeve which is mounted in a clamped state in the casing. The ball joint allows compensation for poor alignment of the second shaft relative to the first shaft. The elastomer sleeve serves to filter the vibrations which are generated by the rotation of the shafts and blades.

Now the cooling module, therefore a fortiori the ventilation device with the sleeve and the ball joint, is located under the bonnet of the car, in a zone with a great potential for being soiled and polluted. This is because dirt and water from the roadway are projected by the tyres into this zone when the vehicle travels. Thus, the casing can tend to become soiled, as can the drive shaft. Now, it is not desirable for dirt to be brought by the shaft inside the sleeve, in which case the ball joint will no longer be able to move correctly and will no longer be able to perform its functions. In the event of soiling, the vibrations will be more intense because they are not being absorbed by the sleeve, the noise generated by the rotation of the shaft will be greater and any misalignment of the shaft could bring about breakage of the shaft.

An object of the present invention is to improve the ventilation device of an electric motor vehicle by providing a novel solution for protecting the sleeve against soiling in the long term while allowing ease of insertion of the ball joint inside the sleeve.

### SUMMARY OF THE INVENTION

This object is achieved by a sleeve for receiving a ball joint which receives a rotation shaft of a bladed member of a ventilation device, the sleeve comprising:
an external cylindrical wall which develops about a center axis X and which defines an internal space;
an open rear face;
a front face for receiving the shaft;
an internal skirt which is connected to the external wall and which defines a housing which is suitable for receiving the ball joint, the housing being partially spherical and having a front opening which opens in the front face, the front opening being suitable for receiving the shaft.

This sleeve is mainly characterized in that it comprises sealing means of the housing in the of the front opening.

The main notion of this invention involves sealing the front opening of the housing, in which the ball joint is located. In this manner, no dirt or humidity can be introduced inside the housing via the opening which is provided for receiving the shaft.

It is necessary to keep a housing clean so that the ball joint can correctly move inside as a result of the lubrication provided to this end.

A lubricant in which dirt or humidity becomes mixed can no longer perform its lubrication function and it is then necessary to periodically disassemble the shaft from the sleeve, the sleeve from the casing and finally the ball joint from the sleeve, in order to be able to clean the housing and to re-introduce clean lubricant.

Such a maintenance operation is no longer necessary as a result of the sealing means which are provided in the region of the front opening of the housing.

According to the various embodiments of the invention, which can be taken together OR separately:
the sealing means of the housing comprise an annular lip which extends from the skirt and which is suitable for coming into contact with the shaft;
the sleeve comprises sealing means with a protection casing for the bladed member;
the sealing means with the protection casing comprise at least one radial projection which extends from the external surface of the external wall and which extends all the way around the external wall;
the sleeve comprises means for inserting the ball joint via its rear face;
the means for inserting the ball joint comprise a rear opening which is provided in the housing and which opens in the internal space and the open rear face;
the rear opening is coaxial with respect to the front opening in accordance with the axis X;
the sleeve is configured in one piece made from an elastomer material.

The invention also relates to an assembly comprising a sleeve as described above and a ball joint which is movable in terms of rotation inside the housing, the ball joint conforming to the internal shape of the housing.

Preferably, the internal skirt has a flexible rear end which delimits the rear opening and which is sized to be able to insert the ball joint by resilient deformation.

According to the invention, the internal skirt has a front end which delimits the front opening and which is provided with a constriction which is sized to be able to insert the shaft and to retain the ball joint in the housing, the constriction supporting the sealing means of the housing.

The invention also relates to a ventilation device which extends in an axial direction X and which comprises:
a bladed member comprising a protection casing for the blades which is composed of a lower half-shell which is assembled with an upper half-shell;
an electric motor comprising a rotor which rotates the bladed member via a first shaft having an axis X which extends from a first end of the bladed member;
   the bladed member comprising a second shaft having an axis X which extends from a second end of the bladed member and which is mounted in an assembly as described above, the shaft being inserted in the sleeve via its front face and mounted in a clamped state in the ball joint, the shaft being in fluid-tight contact with sealing means which are provided on the front face of the sleeve.

In an advantageous manner, the casing comprises a cylindrical receiving chamber for the sleeve which surrounds the external wall of the sleeve, the at least one radial projection being compressed against the casing after it is closed.

In an advantageous manner, the ventilation device comprises axial blocking means for the sleeve relative to the closed casing.

According to one possible variant, these axial blocking means comprise:
a shoulder which is formed on the external wall of the sleeve so as to reduce the external diameter of the sleeve in the region of the front face thereof;
at least one leg which extends perpendicularly to the axis X from the internal surface of the casing and which is suitable for moving into abutment against the shoulder in the event of any axial movement of the sleeve toward the bladed member.

The invention also relates to a method for mounting a ventilation device as described above. This method comprises the following steps:
inserting the ball joint in the housing of the sleeve via the rear face of the sleeve and the rear opening of the housing by axial translation in the direction of the axis X in a first direction;
inserting the shaft in the sleeve via the front face of the sleeve and the front opening of the housing, then clamped mounting of the shaft in the ball joint by axial translation in the direction of the axis X in a second direction opposite the first direction;
closing the casing by assembling the upper half-shell on the lower half-shell so as to compress a radial sealing projection which is provided on the external wall of the sleeve.

Finally, the invention relates to a cooling module for a motor vehicle, comprising a ventilation device as described above, and at least one heat exchanger which is positioned in the path of the air generated by the ventilation device.

### BRIEF DESCRIPTION OF THE FIGURES

Further features and advantages of the invention will become apparent from reading the following detailed description, for an understanding of which reference will be made to the appended drawings, in which:

FIG. 1 shows a perspective, partially sectioned view of a cooling module for an electric motor vehicle;

FIG. 2 shows a sectioned view of a detail of one end of the ventilation device of the cooling module according to FIG. 1;

FIG. 3 shows an exploded, sectioned view of a sleeve according to the prior art, in which a ball joint and a shaft are inserted;

FIG. 4 shows a perspective view of the sleeve of FIG. 3;

FIG. 5 shows an exploded, sectioned view of a sleeve according to a first possible configuration of the invention, in which a ball joint and a shaft are inserted;

FIG. 6 shows an exploded, sectioned view of a sleeve according to a second possible configuration of the invention, in which a ball joint and a shaft are inserted;

FIG. 7 shows a perspective view of the sleeve of FIG. 6.

### DETAILED DESCRIPTION OF THE INVENTION

In the rest of the description, elements having an identical structure or similar functions will be denoted by the same references.

In the rest of the description, axial and radial orientations will be adopted, in a non-limiting manner and without reference to the Earth's gravitational field.

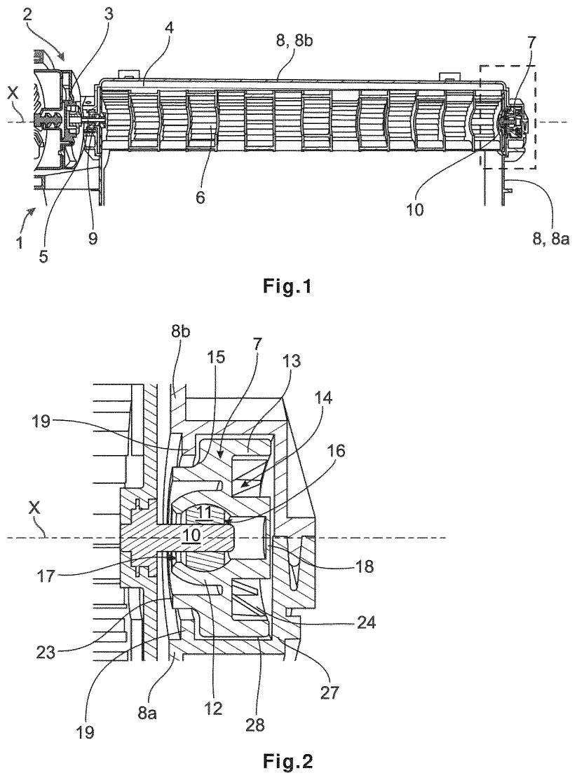

Conventionally, the “axial” direction corresponds to the main extent direction of the ventilation device illustrated by the axis X in FIG. 1 and the “radial” direction is orthogonal to the axial direction.

In the same manner, the terms “external or exterior” and “internal or interior” are used with reference to the radial direction, an external element being radially further away from the axis X than an internal element.

FIG. 1 generally describes a cooling module 1 of a motor vehicle, notably having an electric motor.

As illustrated in FIG. 1, the cooling module 1 comprises a ventilation device 2.

This ventilation device 2 extends axially along the axis X and comprises an electric motor 3 which is associated with a bladed member 4, this bladed member 4 generating an air path toward a heat exchanger (not illustrated) which is located under the bladed member 4.

The connection between the electric motor 3 and the bladed member 4 is brought about via a first shaft 5 which extends from the rotor of the motor 3 and which rotates the bladed member 4.

The blades 6 are orientated tangentially to the axis X which corresponds to the rotation axis of the bladed member 4.

In order to protect the blades 6, the ventilation device 2 comprises a protection casing 8 which is composed by a lower half-shell 8a and an upper half-shell 8b.

The half-shells 8a, 8b are suitable for being nested one inside the other in order to close the casing 8. The lower half-shell 8a acts as a support and the upper half-shell 8b acts as a cover.

The first rotation shaft 5 extends between a first lateral end of the ventilation device 2 and the rotor of the motor 2. This first shaft 5 is fixed in position in a bearing surface of the casing 8 by a roller bearing 9.

The bladed member 4 comprises a second rotation shaft 10 which extends from a second lateral end of the ventilation device 2, this second shaft 10 being connected to an elastomer sleeve 7 which serves to filter the vibrations which are generated by the rotation of this second shaft 10 and the blades 6, and which also serve to compensate for any misalignment of this second shaft 10 relative to the first shaft 5.

FIG. 2 shows in greater detail the connection between the second shaft 10 and the sleeve 7.

In FIG. 2, a sleeve 7 according to the prior art is involved.

This sleeve 7 is received inside a cylindrical receiving chamber 28 which is provided to this end in the casing 8. Thus, the upper half-shell 8b forms half of this chamber 28 and the lower half-shell 8a forms the other half of this chamber 28.

The sleeve 7 comprises a partially spherical housing 16 in which a lubricated ball joint 11 which is free to move in terms of rotation inside the housing 16 is located. The second shaft 10 is mounted in a clamped state in the ball joint 11 so that the ball joint 11 rotates with the shaft 10 inside the housing 16 of the sleeve 7.

The sleeve 7 comprises:
a so-called “front” face 23 for receiving the shaft 10;
and a so-called “rear” face 24 which is opposite the front face 23 and which is located opposite the base of the chamber 28 of the casing 8.

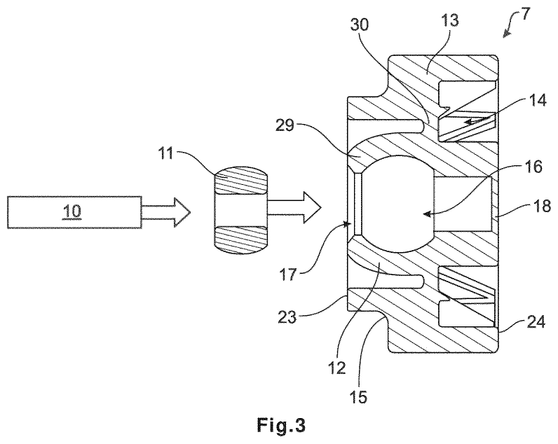

As illustrated in FIG. 3, the assembly order is as follows:
inserting the ball joint 11 inside the sleeve 7 via a front opening 17 which is provided in the receiving housing 16 in an axial direction with an axis X;
inserting the second shaft 10 inside the housing 16 via the front opening 17, then inside the ball joint 11, in an axial direction with an axis X.

The ball joint 11 and the second shaft 10 are both inserted via the front opening 17 along the axis X in the same direction.

Thus, this front opening 17 has to be large enough to be able to receive the ball joint 11.

In this instance, the housing 16 is delimited by an internal skirt 12 which develops inside the sleeve 7. The front end 29 of the skirt 12 thus delimits the front opening 17 of the housing 16. This front end 29 is relatively flexible so as to be able to become deformed in order to readily introduce the ball joint 11 inside the housing 16. The rear end 18 of the skirt 12 is itself closed. The sleeve 7 is a hollow component generated by revolution and generally comprises an external wall 13 with a cylindrical appearance, defining an internal space 14.

Preferably, this external wall 13 conforms to the shape of the chamber 28 of the casing 8 so that there is a minimum of play between the sleeve 7 and the casing 8.

The internal skirt 12 is located in the internal space 14 and is connected to the external wall 13 of the sleeve 7 by a collar 30 which is, for example, annular.

The sleeve 7 is made in one piece, for example, by molding.

The sleeve 7 is composed of a resilient material of the elastomer type, thereby conferring on it a specific flexibility and allowing it to absorb the vibrations. It may, for example, be made from EPDM or chloroprene.

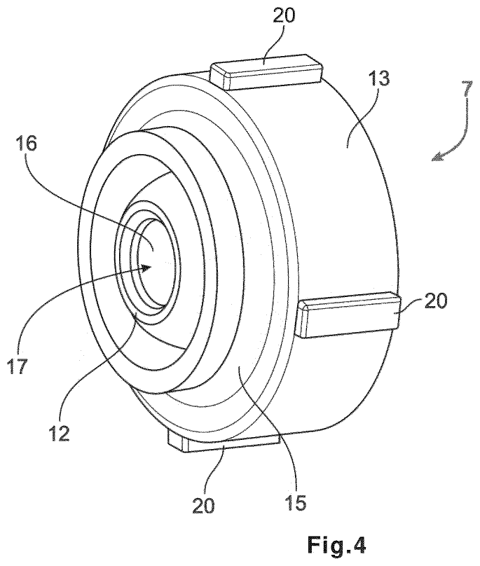

FIG. 4 shows that the external wall 13 of the sleeve 7 is provided with a plurality of axial projections 20 which are suitable for coming into contact with the internal wall of the chamber 28 of the casing 8 and particularly to be compressed when the casing 8 is closed so as to block any radial movement of the sleeve 7 inside the chamber 28.

As illustrated in FIG. 2, in order to block any axial movement of the sleeve 7 inside the chamber 28, there is provided a shoulder 15 on the external wall 13 of the sleeve 7, near a front face 23 of the sleeve 7 which is directed toward the bladed member 4. This shoulder 15 brings about a reduction in the diameter of the sleeve 7. At the same time, there is provided at least one leg or edge 19 which extends perpendicularly to the axis X from the internal surface of the chamber 28 of the casing 8. Thus, the shoulder 15 of the sleeve 7 is suitable for moving into abutment against this leg or edge 19 during any axial movement of the sleeve 7 in the direction of the bladed member 4. Furthermore, the sleeve 7 is blocked axially in the other direction because it is in contact with the base of the chamber 28 of the casing 8.

Thus, the sleeve 7 is completely fixed in position inside the chamber 28 of the casing 8, both radially and axially.

The disadvantage of this sleeve 7 according to the prior art is that dirt and humidity can be introduced inside the housing 16, where the ball joint 11 is located, which consequently prevents optimum movement of the ball joint 11 within the housing 16 because impurities are then located in the lubrication oil.

In the same manner, dirt and humidity can be introduced inside the chamber 28 of the casing 8, particularly between the axial projections 20, and can thus contaminate the entire chamber 28 and the rear portion of the sleeve 7.

This dirt and the humidity lead to a need to carry out periodic maintenance operations in order to clean this entire zone. Now, this is not acceptable for the owners of the vehicles.

The sleeve 7 according to the invention solves the abovementioned problems.

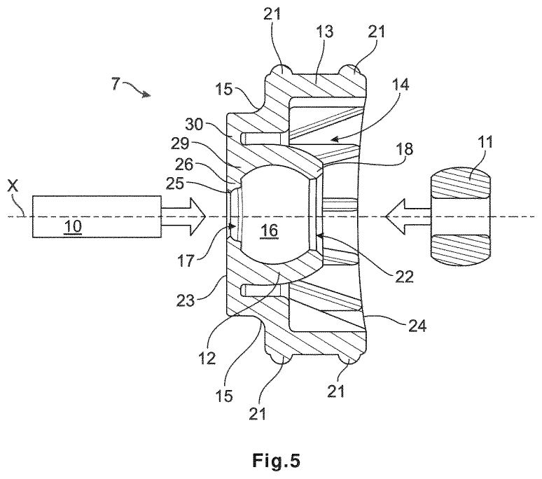

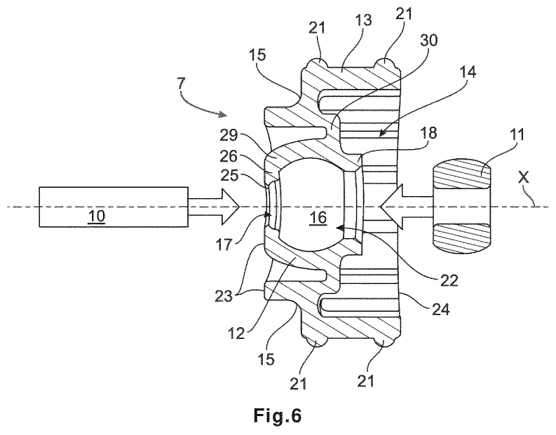

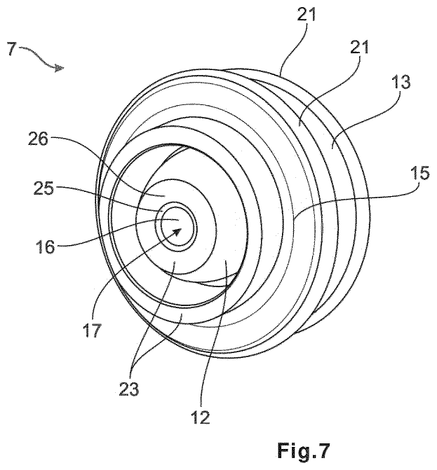

The sleeve 7 according to the invention is illustrated in FIG. 5 according to a first embodiment and in FIGS. 6 and 7 according to a second embodiment.

The sleeve 7 according to the invention as illustrated in FIGS. 5, 6 and 7 includes all the elements described previously for the sleeve 7 of the prior art of FIGS. 2 to 4, with the exception of the axial projections 20 and the rear end 18 of the skirt 12.

This is because the rear end 18 of the skirt 12 is no longer closed but open. Thus, the housing 16 has a front opening 17 which opens at the front face 23 of the sleeve 7 and a rear opening 22 which opens in the internal space 14 of the sleeve 7.

In the sleeve 7 according to the invention, improvements have been applied in order to solve the mentioned problems.

The main problem is the sealing of the housing 16 in which the ball joint 11 is located. To combat this, the internal skirt 12 has sealing means for the housing 16 in the region of the front opening 17. These sealing means comprise an annular sealing lip 25 which bounds this front opening 17 and which comes into contact with the shaft 10 when it is introduced into the housing 16. Sealing is thus brought about between the lip 25 and the shaft 10 which is positioned in the ball joint 11, consequently preventing any dirt and any humidity from being introduced inside the housing 16 via the front opening 17.

In an advantageous manner, in order to prevent an excessively wide and excessively flexible lip 25 from being provided, there is provided a constriction 26 of the front end 29 of the skirt 12 so as to reduce the diameter of the front opening 17 of the housing 16. The front opening 17 thus has a slightly greater diameter than the diameter of the shaft 10 so that it has dimensions which are as similar to the shaft 10 as possible. The annular lip 25 is arranged inside the constriction 26 which allows a narrower, less flexible lip 25, which is more effective for ensuring the sealing, to be provided.

The lip 25 is in sealing contact with the shaft 10.

However, this constriction 26 does not allow introduction of the ball joint 11 via the front face 23 of the sleeve 7 given the reduced diameter of the front opening 17.

For this reason, the rear end 18 of the skirt 12 has a rear opening 22 which has such dimensions as to be able to receive the ball joint 11 by means of resilient deformation. The ball joint 11 is thus introduced inside the housing 16 along the axis X but in the opposite direction relative to the prior art. The ball joint 11 returns to the sleeve 7 via its rear face 24, is introduced inside the internal space 14, then passes through the rear opening 22 of the skirt 12 in order to reach the housing 16.

This rear opening 22 thus corresponds to means for inserting the ball joint 11 via the rear face 24 of the sleeve 7.

The rear opening 22 and the front opening 17 are coaxial along the axis X.

Once the ball joint 11 is inserted in the sleeve 7 and the shaft 10 is inserted in the ball joint 11 of the sleeve 7, the assembly is arranged on the lower shell 8a of the casing 8, then the upper shell 8b of the casing 8 is nested on the lower shell 8a in order to close the casing 8.

With such a rear opening 22 of the housing 16, it will be understood that it is possible for dirt and humidity which would pass between the casing 8 and the external wall 13 of the sleeve 7 to be subsequently introduced inside the sleeve 7 via the rear face 24 thereof, then inside the housing 16 via the rear opening 22.

In order to avoid this, the axial projections 20 which project from the external wall 13 of the sleeve 7 in the direction toward the casing 8 have been replaced with at least one radial projection 21 which projects from the external surface of the external wall 13 of the sleeve 7 in the direction toward the casing 8. Thus, this radial projection 21 extends all the way around the sleeve 7 and acts as a sealing joint which prevents any dirt and any humidity from being introduced inside the chamber 28 beyond this radial projection 21. Preferably, this radial projection 21 is instead arranged in front of the sleeve 7.

Preferably, by way of a precaution and to ensure equilibrium in the positioning of the sleeve 7 in the chamber 28, the sleeve 7 is provided with a first radial projection 21 which is arranged near the front face 23 of the sleeve 7, just downstream of the shoulder 15, and a second radial projection 21 which is arranged near the rear face 24 of the sleeve 7. Thus, there are two sealing barriers which are positioned between the sleeve 7 and the casing 8.

As in the prior art, when the casing 8 is closed, the interior wall of the casing 8 moves into abutment against the radial projections 21 of the sleeve 7 so as to compress them and to seal the chamber 28.

Given the radial arrangement, there is no longer any gap, in which dirt or humidity could be introduced inside the chamber 28.

In FIG. 5, the internal skirt 12 is connected to the external wall 13 via a collar 30 which is located on the front face 23 of the sleeve 7. This is a first possible configuration of the invention.

In FIG. 6, the internal skirt 12 is connected to the external wall 13 via a collar 30 which is located at the center of the sleeve 7. This is a second possible configuration of the invention. will be understood that other configurations are possible in order to connect the skirt 12 to the external wall 13, and are included within the scope of the present invention.

It should be noted that the shape of the casing 8 with its chamber 28 which receives the sleeve 7 according to the invention is identical to the shape described for FIG. 2.

The configurations shown in the cited figures are merely some possible and non-limiting examples of the invention, which by contrast incorporates form and design variants within the scope of the person skilled in the art.

1. A ventilation device which extends in an axial direction and which comprises:
a bladed member comprising a protection casing for the blades which is composed of a lower half-shell which is assembled with an upper half-shell;
an electric motor comprising a rotor which rotates the bladed member via a first shaft having an axis which extends from a first end of the bladed member,
wherein the bladed member comprising a second shaft having the axis which extends from a second end of the bladed member and which is mounted in an assembly comprising a sleeve for receiving a ball joint which receives a rotation shaft of the bladed member of the ventilation device, wherein the sleeve comprising:
an external cylindrical wall which develops about the axis and which defines an internal space;
an open rear face;
a front face for receiving the rotation shaft; and
an internal skirt which is connected to the external cylindrical wall and which defines a housing which is suitable for receiving the ball joint, wherein the housing is partially spherical and having a front opening which opens in the front face,
wherein the front opening is suitable for receiving the rotation shaft,
wherein the ball joint which is movable in terms of rotation inside the housing, the ball joint conforming to an internal shape of the housing,
wherein said sleeve comprises sealing means of the housing in a region of the front opening,
wherein the rotation shaft is inserted in the sleeve via its front face and mounted in a clamped state in the ball joint,
wherein the rotation shaft is in fluid-tight contact with sealing means which are provided on the front face of the sleeve.

2. The ventilation device as claimed in claim 1, wherein the sealing means of the housing comprise an annular lip which extends from the internal skirt and which is suitable for coming into contact with the rotation shaft.

3. The ventilation device as claimed in claim 1, further comprising comprises sealing means with the protection casing for the bladed member.

4. The ventilation device as claimed in claim 3, wherein the sealing means with the protection casing comprise at least one radial projection which extends from an external surface of the external cylindrical wall and which extends all the way around the external cylindrical wall.

5. The ventilation device as claimed in claim 1, further comprising means for inserting the ball joint via its rear face.

6. The ventilation device as claimed in claim 5, wherein the means for inserting the ball joint comprise a rear opening which is provided in the housing and which opens in the internal space and the open rear face.

7. The ventilation device as claimed in claim 6, wherein the rear opening is coaxial with respect to the front opening in accordance with the axis.

8. The ventilation device as claimed in claim 1, wherein the ventilation device is produced in one piece made from an elastomer material.

9. The ventilation device as claimed in claim 4, wherein the protection casing comprises a cylindrical receiving chamber for the sleeve which surrounds the external cylindrical wall of the sleeve, wherein the at least one radial projection being compressed against the protection casing after it is closed.

10. The ventilation device as claimed in claim 1, further comprising comprises axial blocking means for the sleeve relative to a closed casing.

11. The ventilation device as claimed in claim 10, wherein the axial blocking means comprise:
a shoulder which is formed on the external cylindrical wall of the sleeve so as to reduce an external diameter of the sleeve in the region of the front face thereof; and
at least one leg which extends perpendicularly to the axis from the an internal surface of the protection casing and which is suitable for moving into abutment against the shoulder in the event of any axial movement of the sleeve toward the bladed member.

12. A method for assembling the ventilation device as claimed in claim 1, the method comprises:
inserting the ball joint in the housing of the sleeve via the open rear face of the sleeve and a rear opening of the housing by axial translation in a direction of the axis in a first direction;
inserting the rotation shaft in the sleeve via the front face of the sleeve and the front opening of the housing, then clamped mounting of the rotation shaft in the ball joint by axial translation in the direction of the axis in a second direction opposite the first direction; and
closing the protection casing by assembling the upper half-shell on the lower half-shell so as to compress a radial sealing projection which is provided on the external cylindrical wall of the sleeve.

13. A cooling module for a motor vehicle, comprising a the ventilation device as claimed in claim 1, and at least one heat exchanger positioned in a path of air generated by the ventilation device.
